(19) United States
(12) Patent Application Publication
(10) Pub. No.: US 2022/0105854 A1
(43) Pub. Date: Apr. 7, 2022

(54) CONTROL APPARATUS, SYSTEM, LOCKER, VEHICLE, AND DELIVERY METHOD

(71) Applicant: TOYOTA JIDOSHA KABUSHIKI KAISHA, Toyota-shi (JP)

(72) Inventors: Makoto MATSUSHITA, Ichinomiya-shi (JP); Tomo SASAKI, Toyota-shi (JP); Yui NAKAMURA, Nagoya-shi (JP); Satoshi KOMAMINE, Nagoya-shi (JP); Shuichi SAWADA, Nagoya-shi (JP); Tatsuya SUZUKI, Nagoya-shi (JP)

(73) Assignee: TOYOTA JIDOSHA KABUSHIKI KAISHA, Toyota-shi (JP)

(21) Appl. No.: 17/496,315

(22) Filed: Oct. 7, 2021

(30) Foreign Application Priority Data
Oct. 7, 2020 (JP) 2020-169995

(51) Int. Cl. B60P 1/44; B60P 3/00

(52) U.S. Cl. CPC B60P 1/4414; B60W 60/00256; B60P 3/007

(57) ABSTRACT

A control apparatus includes a controller configured to acquire height data indicating a height at which a vehicle carrying a package is to send the package, and perform, according to the acquired height data, control to adjust a height at which a locker is to receive the package from the vehicle.

### CROSS-REFERENCE TO RELATED APPLICATION

This application claims priority to Japanese Patent Application No.

2020-169995, filed on Oct. 7, 2020, the entire contents of which are incorporated herein by reference.

### TECHNICAL FIELD

The present disclosure relates to a control apparatus, a system, a locker, a vehicle, and a delivery method.

### BACKGROUND

Patent Literature (PTL) 1 discloses a store item delivery system including a UAV that delivers an item to a destination, and an automatic locker constructed and arranged to receive the item. The term “UAV” is an abbreviation of unmanned aerial vehicle.

### CITATION LIST

### Patent Literature

PTL 1: JP 2019-505875 A

### SUMMARY

No specific method for placing a package into a locker when the package is delivered to the locker by a vehicle such as an AGV has been considered. The term “AGV” is an abbreviation of automated guided vehicle.

It would be helpful to provide a specific means to place a package from a vehicle into a locker.

A control apparatus according to the present disclosure includes a controller configured to:

acquire height data indicating a height at which a vehicle carrying a package is to send the package; and

perform, according to the acquired height data, control to adjust a height at which a locker is to receive the package from the vehicle.

A control apparatus according to the present disclosure includes a controller configured to:

acquire height data indicating a height at which a locker is to receive a package; and

perform, according to the acquired height data, control to adjust a height at which a vehicle carrying the package is to send the package to the locker.

A delivery method according to the present disclosure includes:

carrying a package by a vehicle;

performing, by a control apparatus, control to adjust, according to either or both of a height at which a locker is to receive the package from the vehicle and a height at which the vehicle is to send the package to the locker, other or both of the heights; and

storing, by the vehicle, the package in the locker.

According to the present disclosure, a specific means to place a package from a vehicle into a locker can be provided.

### BRIEF DESCRIPTION OF THE DRAWINGS

In the accompanying drawings:

FIG. 1 is a diagram illustrating a configuration of a system according to a first embodiment of the present disclosure;

FIG. 2 is a block diagram illustrating a configuration of a control apparatus according to the first embodiment of the present disclosure;

FIG. 3 is a flowchart illustrating operations of the system according to the first embodiment of the present disclosure;

FIG. 4 is a diagram illustrating “before” height adjustment by the system according to the first embodiment of the present disclosure;

FIG. 5 is a diagram illustrating “after” the height adjustment by the system according to the first embodiment of the present disclosure;

FIG. 6 is a diagram illustrating “before” height adjustment by the system according to a second embodiment of the present disclosure;

FIG. 7 is a diagram illustrating “after” the height adjustment by the system according to the second embodiment of the present disclosure;

FIG. 8 is a diagram illustrating “before” height adjustment by the system according to a third embodiment of the present disclosure;

FIG. 9 is a diagram illustrating “after” the height adjustment by the system according to the third embodiment of the present disclosure;

FIG. 10 is a diagram illustrating “before” height adjustment by the system according to a fourth embodiment of the present disclosure;

FIG. 11 is a diagram illustrating “after” the height adjustment by the system according to the fourth embodiment of the present disclosure;

FIG. 12 is a diagram illustrating “before” height adjustment by the system according to a fifth embodiment of the present disclosure; and

FIG. 13 is a diagram illustrating “after” the height adjustment by the system according to the fifth embodiment of the present disclosure.

### DETAILED DESCRIPTION

Hereinafter, some embodiments of the present disclosure will be described with reference to the drawings.

In the drawings, the same or corresponding portions are denoted by the same reference numerals. In the descriptions of the embodiments, detailed descriptions of the same or corresponding portions are omitted or simplified, as appropriate.

A first embodiment, an embodiment of the present disclosure, will be described.

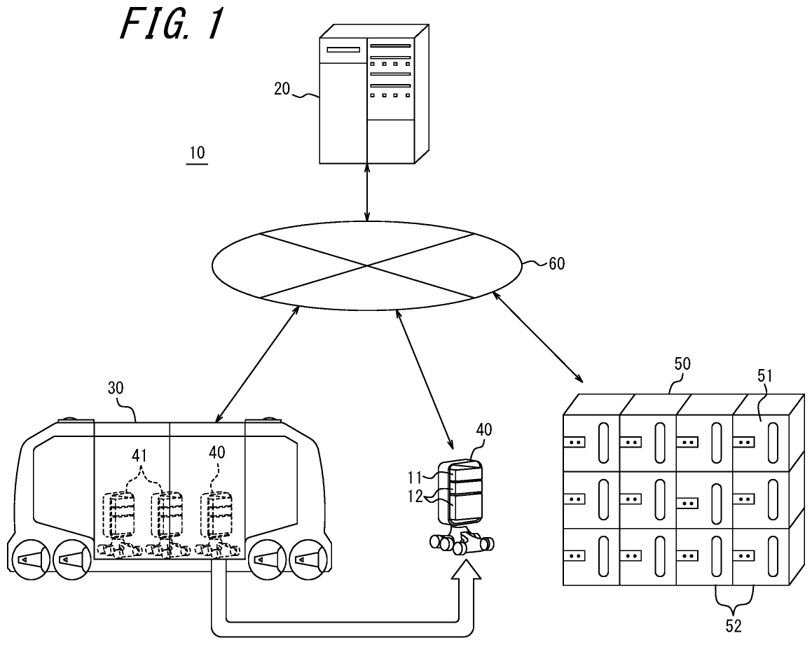

A configuration of a system 10 according to the present embodiment will be described with reference to FIG. 1.

The system 10 includes at least one control apparatus 20, at least one transport vehicle 30, at least one vehicle 40, and at least one locker 50.

The control apparatus 20 is installed in a facility such as a data center. The control apparatus 20 is a computer such as a server that belongs to a cloud computing system or another type of computing system.

The transport vehicle 30 is, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The transport vehicle 30 is an AV in the present embodiment, but may be driven by a driver, or the driving may be automated at any level. The term “AV” is an abbreviation of autonomous vehicle. The automation level is, for example, any one of Level 1 to Level 5 according to the level classification defined by SAE. The name “SAE” is an abbreviation of Society of Automotive Engineers. The transport vehicle 30 may be a MaaS-dedicated vehicle. The term “MaaS” is an abbreviation of Mobility as a Service.

The vehicle 40 is, for example, an AGV or a delivery robot. The vehicle 40 is an AV in the present embodiment, but may be driven by remote control. The vehicle 40 is at least one of two or more vehicles 41 transported by the transport vehicle 30 to a spot near where the locker 50 is installed in the present embodiment, but may independently reach the spot near where the locker 50 is installed. That is, as a variation of the present embodiment, the transport vehicle 30 may be omitted.

The locker 50 is installed in an apartment building in the present embodiment, but may be installed in an office building, a train station, or elsewhere. The locker 50 has two or more storage compartments 52, including a storage compartment 51 in which a package 11 is to be stored, in the present embodiment, but may have only one storage space in which the package 11 is to be stored. The package 11 is at least one of one or more packages 12 carried by the vehicle 40 to the front of the locker 50. Each of the storage compartments 52 is, for example, a storage box with a door.

The control apparatus 20 can communicate with the transport vehicle 30, the vehicle 40, and the locker 50 via a network 60. The transport vehicle 30 may be able to communicate with the vehicle 40 directly or via the network 60. The vehicle 40 may be able to communicate with the locker 50 directly or via the network 60.

The network 60 includes the Internet, at least one WAN, at least one MAN, or any combination thereof. The term “WAN” is an abbreviation of wide area network. The term “MAN” is an abbreviation of metropolitan area network. The network 60 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

An outline of the present embodiment will be described with reference to FIG. 1.

The vehicle 40 carries the package 11 to the front of the locker 50. The control apparatus 20 performs control to adjust, according to either or both of a height at which the locker 50 is to receive the package 11 and a height at which the vehicle 40 is to send the package 11, the other or both of the heights. As the method for performing control to adjust heights, a method such as transmitting signals for height adjustment can be used. The vehicle 40 stores the package 11 in the locker 50.

According to the present embodiment, the height of the vehicle 40 and the height of the locker 50 can be aligned. Therefore, the package 11 can be placed into the locker 50 by a method such as sliding the package 11, when the package 11 is delivered to the locker 50 by the vehicle 40. That is, a specific means to place the package 11 from the vehicle 40 into the locker 50 can be provided.

The control apparatus 20 performs control to adjust a height at which the locker 50 is to receive the package 11 according to a height at which the vehicle 40 is to send the package 11, in the present embodiment, but as a variation of the present embodiment, the control apparatus 20 may perform control to adjust a height at which the vehicle 40 is to send the package 11 according to a height at which the locker 50 is to receive the package 11. Alternatively, as another variation of the present embodiment, the control apparatus 20 may perform control to adjust both of a height at which the locker 50 is to receive the package 11 and a height at which the vehicle 40 is to send the package 11, according to both of the heights.

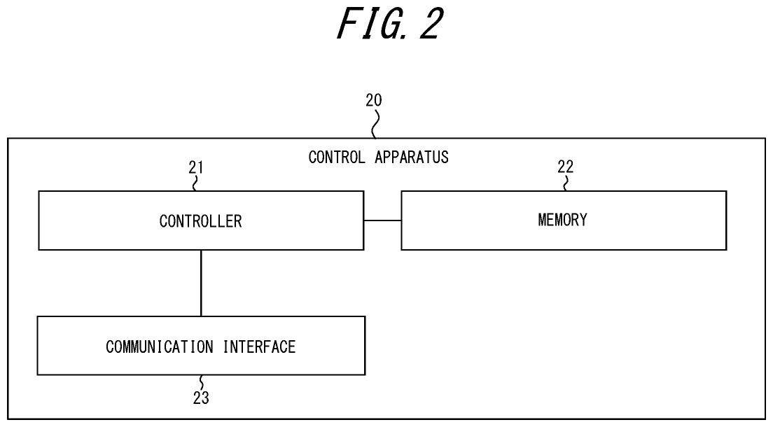

A configuration of the control apparatus 20 according to the present embodiment will be described with reference to FIG. 2.

The control apparatus 20 includes a controller 21, a memory 22, and a communication interface 23.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or any combination thereof. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20.

The communication interface 23 includes at least one interface for communication. The interface for communication is, for example, a LAN interface. The communication interface 23 receives data to be used for the operations of the control apparatus 20, and transmits data obtained by the operations of the control apparatus 20.

The functions of the control apparatus 20 are realized by execution of a program according to the present embodiment by a processor serving as the controller 21. That is, the functions of the control apparatus 20 are realized by software. The program causes a computer to execute the operations of the control apparatus 20, thereby causing the computer to function as the control apparatus 20. That is, the computer executes the operations of the control apparatus 20 in accordance with the program to thereby function as the control apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a programmable circuit or a dedicated circuit serving as the controller 21. That is, some or all of the functions of the control apparatus 20 may be realized by hardware.

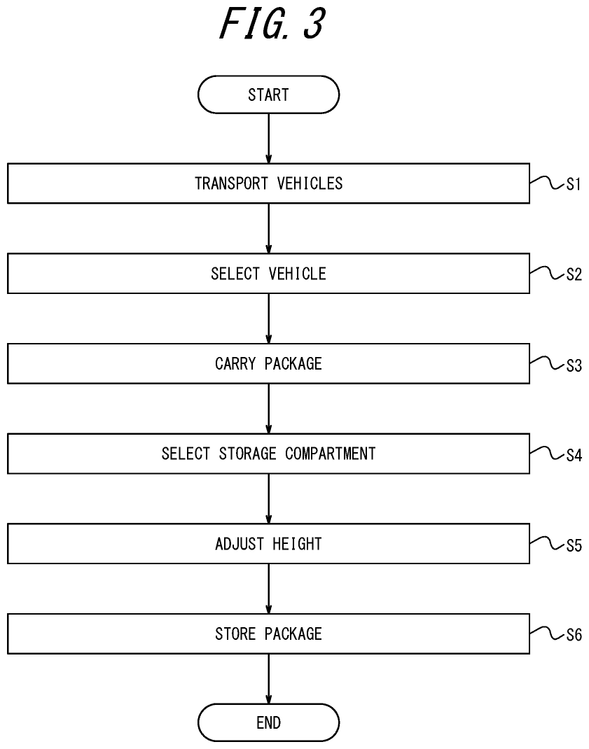

Operations of the system 10 according to the present embodiment will be described with reference to FIG. 3. These operations correspond to a delivery method according to the present embodiment.

In step S1, the controller 21 of the control apparatus 20 controls the communication interface 23 to transmit command data D1. The command data D1 is data commanding the transport vehicle 30 to transport the two or more vehicles 41 to a spot near where the locker 50 is installed. The communication interface 23 transmits the command data D1 to the transport vehicle 30. The transport vehicle 30 receives the command data D1 from the control apparatus 20. The transport vehicle 30 transports the two or more vehicles 41 to the spot near where the locker 50 is installed in accordance with the received command data D1.

In step S2, the controller 21 of the control apparatus 20 controls the communication interface 23 to transmit request data D2a. The request data D2a is data requesting the locker 50 to transmit range data D2b. The range data D2b is data indicating an adjustment range of a height at which the locker 50 is to receive the package 11. The communication interface 23 transmits the request data D2a to the locker 50. The locker 50 receives the request data D2a from the control apparatus 20. The locker 50 transmits the range data D2b to the control apparatus 20 in response to the received request data D2a. The communication interface 23 of the control apparatus 20 receives the range data D2b from the locker 50. The controller 21 of the control apparatus 20 acquires the range data D2b received by the communication interface 23. The controller 21 selects the vehicle 40 from among the two or more vehicles 41 according to the adjustment range indicated by the acquired range data D2b.

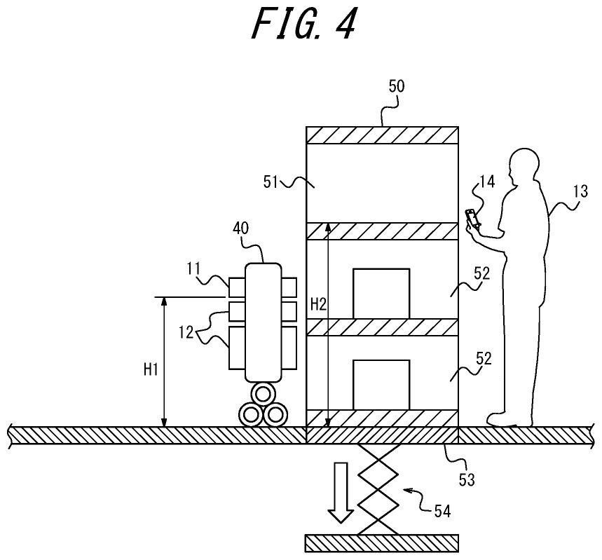

In the present embodiment, as illustrated in FIG. 4, an adjustment mechanism 54 is attached to a floor 53 on which the locker 50 is installed, to adjust the height of the floor 53. The adjustment mechanism 54 is, for example, an electric jack. The adjustment mechanism 54 is connected to and controlled by the locker 50. As the connection method, any technology such as Bluetooth® (Bluetooth is a registered trademark in Japan, other countries, or both) can be used. Assuming that only the top row of the locker 50 is available, the height of a storage compartment 52 in the top row when the height of the floor 53 is lowered to the lowest level by the adjustment mechanism 54 corresponds to the lower limit of the height at which the locker 50 is to receive the package 11. The communication interface 23 of the control apparatus 20 receives data indicating the lower limit, as the range data D2b. The controller 21 of the control apparatus 20 selects, as the vehicle 40, a vehicle 41 that can send the package 11 at a height equal to or greater than the lower limit indicated by the range data D2b, with reference to specification data D2c for each vehicle 41. The specification data D2c may be stored in advance in the memory 22 of the control apparatus 20 or in an external storage, or may be acquired from each vehicle 41.

In step S3, the controller 21 of the control apparatus 20 controls the communication interface 23 to transmit command data D3. The command data D3 is data commanding the vehicle 40 to carry the package 11 to the front of the locker 50. The communication interface 23 transmits the command data D3 to the vehicle 40. The vehicle 40 receives the command data D3 from the control apparatus 20. The vehicle 40 carries the package 11 to the front of the locker 50 in accordance with the received command data D3.

In step S4, the controller 21 of the control apparatus 20 controls the communication interface 23 to transmit request data D4a. The request data D4a is data requesting the locker 50 to transmit status data D4b. The status data D4b is data indicating availability of the locker 50. The communication interface 23 transmits the request data D4a to the locker 50. The locker 50 receives the request data D4a from the control apparatus 20. The locker 50 transmits the status data D4b to the control apparatus 20 in response to the received request data D4a. The communication interface 23 of the control apparatus 20 receives the status data D4b from the locker 50. The controller 21 of the control apparatus 20 acquires the status data D4b received by the communication interface 23. The controller 21 selects the storage compartment 51 from among the two or more storage compartments 52 according to the availability indicated by the acquired status data D4b.

For example, suppose that only the top row of the locker 50 is available, as illustrated in FIG. 4. The communication interface 23 of the control apparatus 20 receives, as the status data D4b, data indicating that a storage compartment 52 in the top row is available. The controller 21 of the control apparatus 20 selects, as the storage compartment 51, the storage compartment 52 that is indicated to be available by the status data D4b.

The storage compartment 51 may be selected according to an attribute of the package 11 instead of or along with the availability of the locker 50. In that case, the communication interface 23 of the control apparatus 20 receives attribute data D4c from the vehicle 40. The attribute data D4c is data indicating an attribute of the package 11. The controller 21 of the control apparatus 20 acquires the attribute data D4c received by the communication interface 23. The controller 21 selects the storage compartment 51 from among the two or more storage compartments 52 according to the attribute indicated by the acquired attribute data D4c.

For example, the communication interface 23 of the control apparatus 20 receives, as the attribute data D4c, data indicating the weight, the size, or the shape of the package 11. The controller 21 of the control apparatus 20 selects, as the storage compartment 51, a storage compartment 52 that can accommodate the weight, the size, or the shape indicated by the attribute data D4c, with reference to specification data D4d for each storage compartment 52. The specification data D4d may be stored in advance in the memory 22 of the control apparatus 20 or in an external storage, or may be acquired from the locker 50.

The storage compartment 51 may be designated externally, instead of being selected internally by the control apparatus 20. In that case, the communication interface 23 of the control apparatus 20 receives designation data D4e from the vehicle 40. The designation data D4e is data designating the storage compartment 51. The controller 21 of the control apparatus 20 acquires the designation data D4e received by the communication interface 23.

In step S5, the controller 21 of the control apparatus 20 controls the communication interface 23 to transmit request data D5a. The request data D5a is data requesting the vehicle 40 to transmit height data D5b. The height data D5b is data indicating a height at which the vehicle 40 is to send the package 11. The communication interface 23 transmits the request data D5a to the vehicle 40. The vehicle 40 receives the request data D5a from the control apparatus 20. The vehicle 40 transmits the height data D5b to the control apparatus 20 in response to the received request data D5a. The communication interface 23 of the control apparatus 20 receives the height data D5b from the vehicle 40. The controller 21 of the control apparatus 20 acquires the height data D5b received by the communication interface 23. The controller 21 performs control to adjust the height at which the locker 50 is to receive the package 11, according to the height indicated by the acquired height data D5b. Specifically, the controller 21 performs control to adjust the height of the storage compartment 51, as the height at which the locker 50 is to receive the package 11.

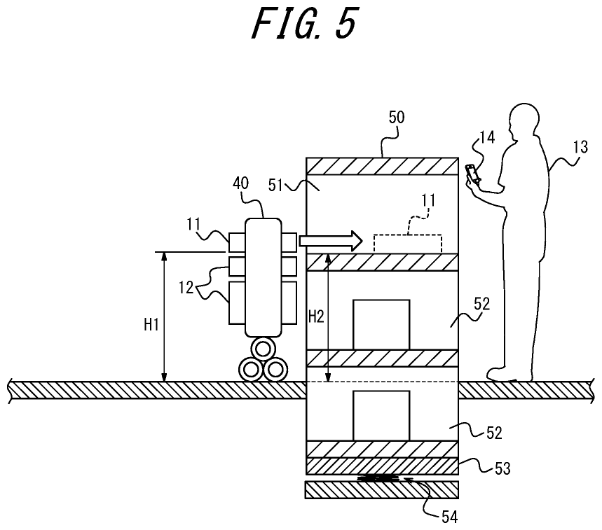

In the present embodiment, as illustrated in FIGS. 4 and 5, a height H1 at which the vehicle 40 is to slide the package 11 corresponds to the height at which the vehicle 40 is to send the package 11. The height H2 of the storage compartment 51 corresponds to the height at which the locker 50 is to receive the package 11. For example, suppose that the storage compartment 51 is in the top row, as illustrated in FIG. 4. The communication interface 23 of the control apparatus 20 receives, as the height data D5b, data indicating the height H1 at which the vehicle 40 is to slide the package 11. The controller 21 of the control apparatus 20 identifies, with reference to specification data D5c for the locker 50, the height H2 of the storage compartment 51 when the height of the floor 53 on which the locker 50 is installed is not lowered. The specification data D5c may be stored in advance in the memory 22 of the control apparatus 20 or in an external storage, or may be acquired from the locker 50. In a case in which the identified height H2 is higher than the height H1 indicated by the height data D5b, the controller 21 controls the communication interface 23 to transmit command data D5d. The command data D5d is data commanding the locker 50 to lower the height of the floor 53 until the height H2 coincides with or lowers slightly below the height H1. The communication interface 23 transmits the command data D5d to the locker 50. The locker 50 receives the command data D5d from the control apparatus 20. The locker 50 controls the adjustment mechanism 54 to lower the height of the floor 53 in accordance with the received command data D5d.

For example, suppose that H1<H2, as illustrated in FIG. 4, before the height of the floor 53 is adjusted. The controller 21 of the control apparatus 20 performs control to adjust H2 as the height at which the locker 50 is to receive the package 11 by performing control to adjust the height of the floor 53. As a result, H1≥H2, as illustrated in FIG. 5.

Instead of acquiring the height data D5b from the vehicle 40, the height data D5b may be acquired from the locker 50. Specifically, an image of the vehicle 40 may be captured by a camera attached to the locker 50, and the captured image or a result of analyzing the image may be acquired as the height data D5b.

In step S6, the controller 21 of the control apparatus 20 controls the communication interface 23 to transmit command data D6. The command data D6 is data commanding the vehicle 40 to store the package 11 in the locker 50. The communication interface 23 transmits the command data D6 to the vehicle 40. The vehicle 40 receives the command data D6 from the control apparatus 20. The vehicle 40 stores the package 11 in the locker 50 in accordance with the received command data D6. Specifically, the vehicle 40 slides the package 11 into the storage compartment 51.

In the present embodiment, after step S6, as illustrated in FIGS. 4 and 5, the storage compartment 51 is unlocked when a person 13 who is to receive the package 11 holds a terminal apparatus 14, such as a mobile phone, a smartphone, or a tablet, against the locker 50. For example, a door of a storage box serving as the storage compartment 51 opens automatically. Key data D7 required to unlock the storage compartment 51 is passed from the control apparatus 20 to the vehicle 40, the locker 50, and the terminal apparatus 14 in turn, and is disabled when the package 11 is received.

In FIGS. 4 and 5, the left side and the right side of the locker 50 may be the front and the back, respectively, or the left side and the right side of the locker 50 may be the back and the front, respectively. That is, the package 11 may be put in from the front of the locker 50 and taken out from the back, or may be put in from the back of the locker 50 and taken out from the front. Alternatively, the package 11 may be put in from the front of the locker 50 and taken out from the front.

As described above, in the present embodiment, the controller 21 of the control apparatus 20 acquires height data D5b indicating a height at which the vehicle 40 carrying the package 11 to the front of the locker 50, in which the package 11 is to be stored, is to send the package 11. The controller 21 performs control to adjust a height at which the locker 50 is to receive the package 11, according to the height indicated by the acquired height data D5b.

According to the present embodiment, the height of the vehicle 40 and the height of the locker 50 can be aligned. Therefore, the package 11 can be slid into the locker 50 when the package 11 is delivered to the locker 50 by the vehicle 40. That is, a specific means to place the package 11 from the vehicle 40 into the locker 50 can be provided.

According to the present embodiment, when the package 11 is stored in the locker 50 after the vehicle 40 arrives in front of the apartment building, even if the position of the locker 50 is too high, the vehicle 40 can store the package 11 by itself by lowering the position of the locker 50. As a variation of the present embodiment, when the package 11 is stored in the locker 50, even if the position of the locker 50 is too low, the vehicle 40 may be able to store the package 11 by itself by raising the position of the locker 50.

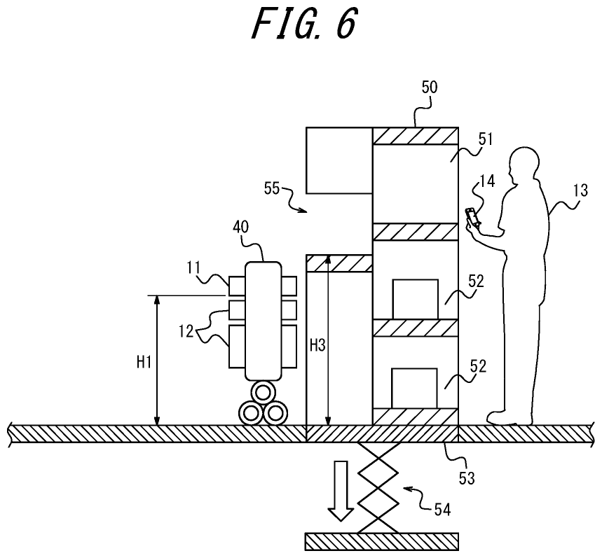

As a variation of the first embodiment, the locker 50 may further have an entrance 55, as illustrated in FIG. 6. A second embodiment, such a variation, will be described.

Regarding the process in step S2, the differences from that of the first embodiment will be described.

In the present embodiment, an article placed in the entrance 55 is to be stored in each of the storage compartments 52. The article placed in the entrance 55 is moved to one of the storage compartments 52 by, for example, a stacker crane or a conveyor. Regardless of availability of the locker 50, the height of the entrance 55 when the height of the floor 53 is lowered to the lowest level by the adjustment mechanism 54 corresponds to the lower limit of a height at which the locker 50 is to receive the package 11. The communication interface 23 of the control apparatus 20 receives data indicating the lower limit, as the range data D2b. The controller 21 of the control apparatus 20 selects, as the vehicle 40, a vehicle 41 that can send the package 11 at a height equal to or greater than the lower limit indicated by the range data D2b, with reference to the specification data D2c for each vehicle 41.

Regarding the process in step S5, the differences from that of the first embodiment will be described.

In step S5, the controller 21 of the control apparatus 20 performs control to adjust the height of the entrance 55, not the height of the storage compartment 51, as the height at which the locker 50 is to receive the package 11.

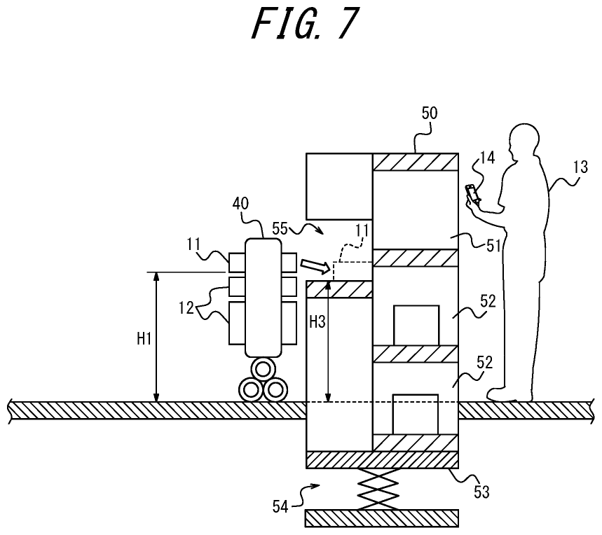

In the present embodiment, as illustrated in FIGS. 6 and 7, a height H1 at which the vehicle 40 is to slide the package 11 corresponds to a height at which the vehicle 40 is to send the package 11. The height H3 of the entrance 55 corresponds to the height at which the locker 50 is to receive the package 11. The communication interface 23 of the control apparatus 20 receives, as the height data D5b, data indicating the height H1 at which the vehicle 40 is to slide the package 11. The controller 21 of the control apparatus 20 identifies, with reference to the specification data D5c for the locker 50, the height H3 of the entrance 55 when the height of the floor 53 on which the locker 50 is installed is not lowered. In a case in which the identified height H3 is higher than the height H1 indicated by the height data D5b, the controller 21 controls the communication interface 23 to transmit command data D5e. The command data D5e is data commanding the locker 50 to lower the height of the floor 53 until the height H3 coincides with or lowers slightly below the height H1. The communication interface 23 transmits the command data D5e to the locker 50. The locker 50 receives the command data D5e from the control apparatus 20. The locker 50 controls the adjustment mechanism 54 to lower the height of the floor 53 in accordance with the received command data D5e.

For example, suppose that H1<H3, as illustrated in FIG. 6, before the height of the floor 53 is adjusted. The controller 21 of the control apparatus 20 performs control to adjust H3 as the height at which the locker 50 is to receive the package 11 by performing control to adjust the height of the floor 53. As a result, H1≥H3, as illustrated in FIG. 7.

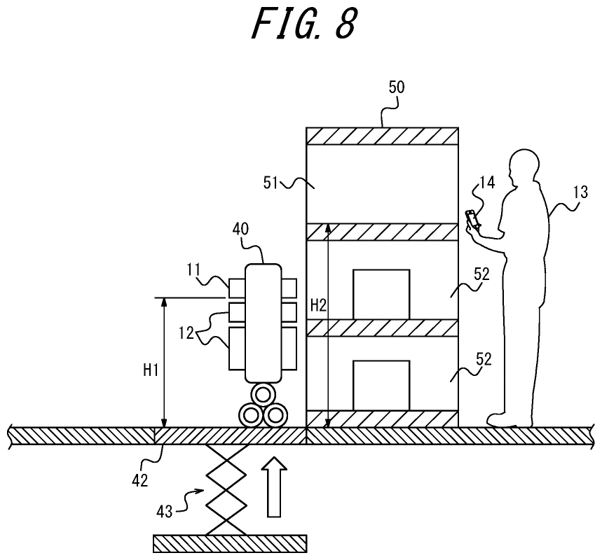

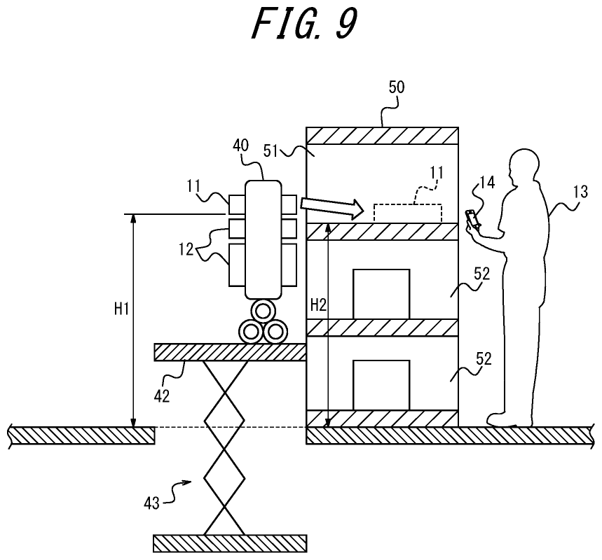

As another variation of the first embodiment, as illustrated in FIGS. 8 and 9, a height at which the vehicle 40 is to send the package 11 may be adjusted according to a height at which the locker 50 is to receive the package 11. A third embodiment, such a variation, will be described.

Regarding the process in step S2, the differences from that of the first embodiment will be described.

In step S2, the controller 21 of the control apparatus 20 controls the communication interface 23 to transmit request data D2d. The request data D2d is data requesting each vehicle 41 to transmit range data D2e. The range data D2e is data indicating an adjustment range of a height at which each vehicle 41 is to send the package 11. The communication interface 23 transmits the request data D2d to each vehicle 41. Each vehicle 41 receives the request data D2d from the control apparatus 20. Each vehicle 41 transmits the range data D2e to the control apparatus 20 in response to the received request data D2d. The communication interface 23 of the control apparatus 20 receives the range data D2e from each vehicle 41. The controller 21 of the control apparatus 20 acquires the range data D2e received by the communication interface 23. The controller 21 selects the vehicle 40 from among the two or more vehicles 41 according to the adjustment range indicated by the acquired range data D2e.

In the present embodiment, as illustrated in FIG. 8, an adjustment mechanism 43 is attached to a floor 42 in front of the locker 50, to adjust the height of the floor 42. The adjustment mechanism 43 is, for example, an electric jack. The adjustment mechanism 43 can be connected to each vehicle 41 and is controlled by a vehicle 41 to which the adjustment mechanism 43 is connected. As the connection method, any technology such as Bluetooth® can be used. Assuming that each vehicle 41 carries the package 11 to the front of the locker 50 and is placed on the floor 42, the height of the package 11 when the height of the floor 42 is raised to the highest level by the adjustment mechanism 43 corresponds to the upper limit of the height at which each vehicle 41 is to send the package 11. The communication interface 23 of the control apparatus 20 receives data indicating the upper limit, as the range data D2e. Assuming that only the top row of the locker 50 is available, it is a condition on which the locker 50 can receive the package 11 that the height of a storage compartment 52 in the top row is equal to or less than the upper limit indicated by the range data D2e. The controller 21 of the control apparatus 20 selects, as the vehicle 40, a vehicle 41 that satisfies such a condition with reference to specification data D2f for the locker 50. The specification data D2f may be stored in advance in the memory 22 of the control apparatus 20 or in an external storage, or may be acquired from the locker 50.

Regarding the process in step S5, the differences from that of the first embodiment will be described.

In step S5, the controller 21 of the control apparatus 20 controls the communication interface 23 to transmit request data D5f. The request data D5f is data requesting the locker 50 to transmit height data D5g. The height data D5g is data indicating a height at which the locker 50 is to receive the package 11. The communication interface 23 transmits the request data D5f to the locker 50. The locker 50 receives the request data D5f from the control apparatus 20. The locker 50 transmits the height data D5g to the control apparatus 20 in response to the received request data D5f. The communication interface 23 of the control apparatus 20 receives the height data D5g from the locker 50. The controller 21 of the control apparatus 20 acquires the height data D5g received by the communication interface 23. The controller 21 performs control to adjust a height at which the vehicle 40 is to send the package 11, according to the height indicated by the acquired height data D5g.

In the present embodiment, as illustrated in FIGS. 8 and 9, a height H1 at which the vehicle 40 is to slide the package 11 corresponds to the height at which the vehicle 40 is to send the package 11. The height H2 of the storage compartment 51 corresponds to the height at which the locker 50 is to receive the package 11. The communication interface 23 of the control apparatus 20 receives, as the height data D5g, data indicating the height H2 of the storage compartment 51. The controller 21 of the control apparatus 20 identifies, with reference to specification data D5h for the vehicle 40, the height H1 at which the vehicle 40 is to slide the package 11 when the height of the floor 42 in front of the locker 50 is not raised. The specification data D5h may be stored in advance in the memory 22 of the control apparatus 20 or in an external storage, or may be acquired from the vehicle 40. In a case in which the identified height H1 is lower than the height H2 indicated by the height data D5g, the controller 21 controls the communication interface 23 to transmit command data D5i. The command data D5i is data commanding the vehicle 40 to raise the height of the floor 42 until the height H1 coincides with or rises slightly above the height H2. The communication interface 23 transmits the command data D5i to the vehicle 40. The vehicle 40 receives the command data D5i from the control apparatus 20. The vehicle 40 controls the adjustment mechanism 43 to raise the height of the floor 42 in accordance with the received command data D5i.

For example, suppose that H1<H2, as illustrated in FIG. 8, before the height of the floor 42 is adjusted. The controller 21 of the control apparatus 20 performs control to adjust H1 as the height at which the vehicle 40 is to send the package 11 by performing control to adjust the height of the floor 42. As a result, H1≥H2, as illustrated in FIG. 9.

Instead of acquiring the height data D5g from the locker 50, the height data D5g may be acquired from the vehicle 40. Specifically, an image of the locker 50 may be captured by a camera attached to the vehicle 40, and the captured image or a result of analyzing the image may be acquired as the height data D5g.

According to the present embodiment, when the package 11 is stored in the locker 50 after the vehicle 40 arrives in front of the apartment building, even if the position of the locker 50 is too high, the vehicle 40 can store the package 11 by itself by raising the position of the vehicle 40. As a variation of the present embodiment, when the package 11 is stored in the locker 50, even if the position of the locker 50 is too low, the vehicle 40 may be able to store the package 11 by itself by lowering the position of the vehicle 40.

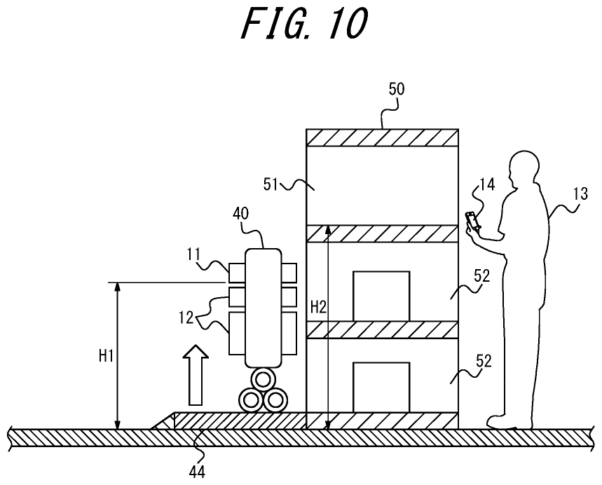

As a variation of the third embodiment, a conveyor 44 may be installed in place of the adjustment mechanism 43, as illustrated in FIG. 10. A fourth embodiment, such a variation, will be described.

Regarding the process in step S2, the differences from that of the third embodiment will be described.

In the present embodiment, as illustrated in FIG. 10, a conveyor 44 on which the vehicle 40 is placed is installed in front of the locker 50. The conveyor 44 is connected to and controlled by the vehicle 40. As the connection method, any technology such as Bluetooth® can be used. Assuming that each vehicle 41 carries the package 11 to the front of the locker 50 and is placed on the conveyor 44, the height of the package 11 when the conveyor 44 is moved to the highest position corresponds to the upper limit of a height at which each vehicle 41 is to send the package 11. The communication interface 23 of the control apparatus 20 receives data indicating the upper limit, as the range data D2e. Assuming that only the top row of the locker 50 is available, it is a condition on which the locker 50 can receive the package 11 that the height of a storage compartment 52 in the top row is equal to or less than the upper limit indicated by the range data D2e. The controller 21 of the control apparatus 20 selects, as the vehicle 40, a vehicle 41 that satisfies such a condition with reference to the specification data D2f for the locker 50.

Regarding the process in step S5, the differences from that of the third embodiment will be described.

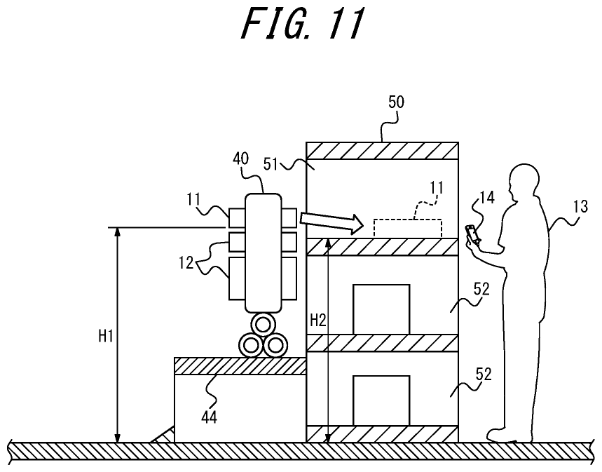

In the present embodiment, as illustrated in FIGS. 10 and 11, a height H1 at which the vehicle 40 is to slide the package 11 corresponds to a height at which the vehicle 40 is to send the package 11. The height H2 of the storage compartment 51 corresponds to a height at which the locker 50 is to receive the package 11. The communication interface 23 of the control apparatus 20 receives, as the height data D5g, data indicating the height H2 of the storage compartment 51. The controller 21 of the control apparatus 20 identifies, with reference to the specification data D5h for the vehicle 40, the height H1 at which the vehicle 40 is to slide the package 11 when the conveyor 44 installed in front of the locker 50 is not moved. In a case in which the identified height H1 is lower than the height H2 indicated by the height data D5g, the controller 21 controls the communication interface 23 to transmit command data D5j.

The command data D5j is data commanding the vehicle 40 to move the conveyor 44 in a vertical direction until the height H1 coincides with or rises slightly above the height H2. The communication interface 23 transmits the command data D5j to the vehicle 40. The vehicle 40 receives the command data D5j from the control apparatus 20. The vehicle 40 controls the conveyor 44 to move in the vertical direction in accordance with the received command data D5j.

For example, suppose that H1<H2, as illustrated in FIG. 10, before the conveyor 44 is moved. The controller 21 of the control apparatus 20 performs control to adjust H1 as the height at which the vehicle 40 is to send the package 11 by controlling the conveyor 44 to move in the vertical direction. As a result, H1≥H2, as illustrated in FIG. 11.

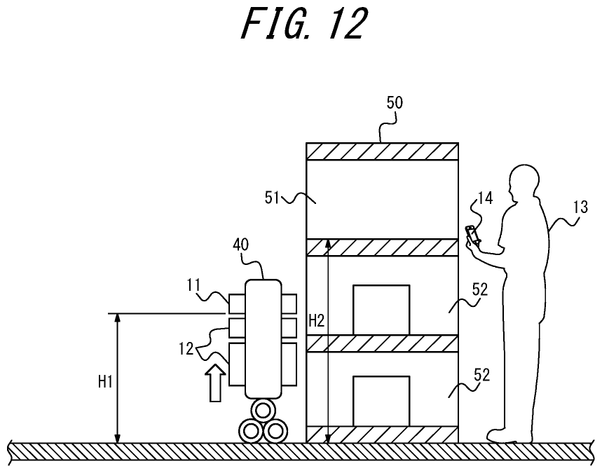

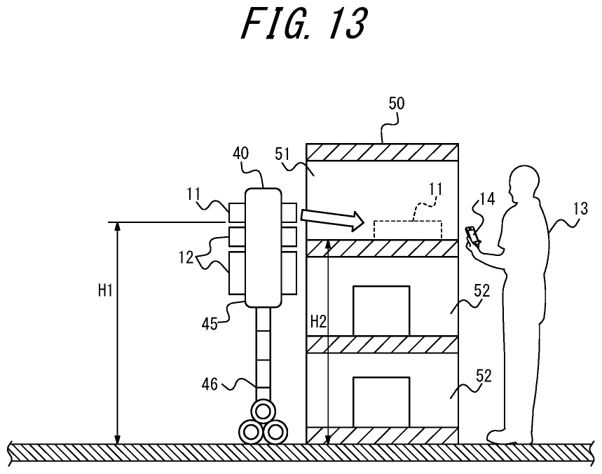

As another variation of the third embodiment, the height of the vehicle 40 itself may be variable, as illustrated in FIGS. 12 and 13. A fifth embodiment, such a variation, will be described.

Regarding the process in step S2, the differences from that of the third embodiment will be described.

In the present embodiment, as illustrated in FIG. 13, each vehicle 41 is provided with an adjustment mechanism 46 to adjust the height of a corresponding portion 45 of each vehicle 41 on which the package 11 is loaded. The adjustment mechanism 46 is, for example, a motorized telescoping post. The height of the package 11 when the height of the corresponding portion 45 of each vehicle 41 on which the package 11 is loaded is raised to the highest level by the adjustment mechanism 46 corresponds to the upper limit of a height at which each vehicle 41 is to send the package 11. The communication interface 23 of the control apparatus 20 receives data indicating the upper limit, as the range data D2e. Assuming that only the top row of the locker 50 is available, it is a condition on which the locker 50 can receive the package 11 that the height of a storage compartment 52 in the top row is equal to or less than the upper limit indicated by the range data D2e. The controller 21 of the control apparatus 20 selects, as the vehicle 40, a vehicle 41 that satisfies such a condition with reference to the specification data D2f for the locker 50.

Regarding the process in step S5, the differences from that of the third embodiment will be described.

In the present embodiment, as illustrated in FIGS. 12 and 13, a height H1 at which the vehicle 40 is to slide the package 11 corresponds to a height at which the vehicle 40 is to send the package 11. The height H2 of the storage compartment 51 corresponds to a height at which the locker 50 is to receive the package 11. The communication interface 23 of the control apparatus 20 receives, as the height data D5g, data indicating the height H2 of the storage compartment 51. The controller 21 of the control apparatus 20 identifies, with reference to the specification data D5h for the vehicle 40, the height H1 at which the vehicle 40 is to slide the package 11 when the height of the corresponding portion 45 of the vehicle 40 on which the package 11 is loaded is not raised. In a case in which the identified height H1 is lower than the height H2 indicated by the height data D5g, the controller 21 controls the communication interface 23 to transmit command data D5k. The command data D5k is data commanding the vehicle 40 to raise the height of the corresponding portion 45 of the vehicle 40 on which the package 11 is loaded until the height H1 coincides with or rises slightly above the height H2. The communication interface 23 transmits the command data D5k to the vehicle 40. The vehicle 40 receives the command data D5k from the control apparatus 20. The vehicle 40 raises the height of the corresponding portion 45 of the vehicle 40 on which the package 11 is loaded in accordance with the received command data D5k.

For example, suppose that H1<H2, as illustrated in FIG. 12, before the height of the corresponding portion 45 of the vehicle 40 on which the package 11 is loaded is adjusted. The controller 21 of the control apparatus 20 performs control to adjust H1 as the height at which the vehicle 40 is to send the package 11 by performing control to adjust the height of the corresponding portion 45 of the vehicle 40 on which the package 11 is loaded. As a result, H1≥H2, as illustrated in FIG. 13.

The present disclosure is not limited to the embodiments described above. For example, two or more blocks illustrated in the block diagram may be integrated, or one block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

For example, the control apparatus 20 may be included in a transport vehicle 30. Alternatively, the control apparatus 20 may be included in a vehicle 40. Alternatively, the control apparatus 20 may be included in the locker 50.

The height adjustment may be performed after a vehicle 40 has arrived at a locker 50, but from the standpoint of saving time, the height adjustment is preferably completed prior to arrival at the locker 50. In such an example, an arrival time is estimated based on positional information for the vehicle 40. In the case of adjusting the height of a locker 50, as in the first or second embodiment, the height is adjusted preferably on the condition that no one is operating the locker 50 and even more preferably on the condition that no one is present around the locker 50. To determine the conditions, images from surveillance cameras or the like are used. In the case of adjusting the height of a storage portion of a vehicle 40, as in the fifth embodiment, the height is adjusted on the condition that, after the vehicle 40 has been loaded onto a transport vehicle 30, the vehicle 40 is at a standstill, such as while waiting for the transport vehicle 30 to depart or while waiting at a traffic light. That is, the height is adjusted under more stable conditions.

1. A control apparatus comprising a controller configured to:
acquire height data indicating a height at which a vehicle carrying a package is to send the package; and
perform, according to the acquired height data, control to adjust a height at which a locker is to receive the package from the vehicle.

2. The control apparatus according to claim 1, wherein the controller is configured to perform control to adjust the height at which the locker is to receive the package, by performing control to adjust a height of a floor on which the locker is installed.

3. The control apparatus according to claim 1, wherein the controller is configured to acquire range data indicating an adjustment range of the height at which the locker is to receive the package, and select the vehicle from among two or more vehicles according to the adjustment range indicated by the acquired range data.

4. The control apparatus according to claim 1, wherein
the locker has two or more storage compartments, and
the controller is configured to perform control to adjust a height of a storage compartment in which the package is to be stored, as the height at which the locker is to receive the package.

5. The control apparatus according to claim 4, wherein the controller is configured to acquire status data indicating availability of the locker, and select the storage compartment in which the package is to be stored from among the two or more storage compartments according to the availability indicated by the acquired status data.

6. The control apparatus according to claim 4, wherein the controller is configured to acquire attribute data indicating an attribute of the package, and select the storage compartment in which the package is to be stored from among the two or more storage compartments according to the attribute indicated by the acquired attribute data.

7. The control apparatus according to claim 4, further comprising a communication interface configured to receive, from the vehicle, designation data designating the storage compartment in which the package is to be stored.

8. The control apparatus according to claim 1, wherein
the locker has an entrance and two or more storage compartments in each of which an article placed in the entrance is to be stored, and
the controller is configured to perform control to adjust a height of the entrance, as the height at which the locker is to receive the package.

9. The control apparatus according to claim 1, further comprising a communication interface configured to receive the height data from the vehicle.

10. A system comprising:
the control apparatus according to claim 1; and
the locker and/or the vehicle.

11. A locker comprising the control apparatus according to claim 1.

12. A control apparatus comprising a controller configured to:
acquire height data indicating a height at which a locker is to receive a package; and
perform, according to the acquired height data, control to adjust a height at which a vehicle carrying the package is to send the package to the locker.

13. The control apparatus according to claim 12, wherein the controller is configured to perform control to adjust the height at which the vehicle is to send the package, by performing control to adjust a height of a floor in front of the locker.

14. The control apparatus according to claim 12, wherein the controller is configured to perform control to adjust the height at which the vehicle is to send the package, by controlling a conveyor that is installed in front of the locker and on which the vehicle is placed to move in a vertical direction.

15. The control apparatus according to claim 12, wherein the controller is configured to perform control to adjust the height at which the vehicle is to send the package, by performing control to adjust a height of a portion of the vehicle on which the package is loaded.

16. The control apparatus according to claim 12, wherein the controller is configured to acquire range data indicating an adjustment range of a height at which each of two or more vehicles is to send the package, and select the vehicle from among the two or more vehicles according to the adjustment range indicated by the acquired range data.

17. The control apparatus according to claim 12, further comprising a communication interface configured to receive the height data from the locker.

18. A system comprising:
the control apparatus according to claim 12; and
the locker and/or the vehicle.

19. A vehicle comprising the control apparatus according to claim 12.

20. A delivery method comprising:
carrying a package by a vehicle;
performing, by a control apparatus, control to adjust, according to either or both of a height at which a locker is to receive the package from the vehicle and a height at which the vehicle is to send the package to the locker, other or both of the heights; and
storing, by the vehicle, the package in the locker.
